(19) United States
(12) Patent Application Publication
(10) Pub. No.: US 2022/0292603 A1
(43) Pub. Date: Sep. 15, 2022

(54) System and method for efficiently selecting and transferring non-cash assets from a donor's investment account to charitable or non-charitable recipients on a systematic, recurring basis

(71) Applicant: Morgan Stanley Services Group Inc., Boston, MA (US)

(72) Inventor: Thomas E. Faust, JR., Boston, MA (US)

(73) Assignee: Morgan Stanley Services Group Inc., Boston, MA (US)

(21) Appl. No.: 17/684,746

(22) Filed: Mar. 2, 2022

Related U.S. Application Data
(60) Provisional application No. 63/158,568, filed on Mar. 9, 2021.

(51) Int. Cl. G06Q 40/06; G06Q 20/10; G06Q 40/02

(52) U.S. Cl. CPC G06Q 40/06; G06Q 20/10; G06Q 40/02

(57) ABSTRACT

A portfolio management and securities delivery system and method includes a specialized Donor Investment Account Computer (DIAC), Portfolio Optimizer Computer (POC), Market Trading Computer (MTC), and Recipient Account Computer (RAC). The DIAC transmits portfolio data to the POC, which applies a set of rules to a Donor Investment Account portfolio to generate a Donor Selection for contribution of non-cash assets, and then tags and transmits the Donor Selection to the MTC. The MTC receives and decrypts the translated Donor Selection to effect transfer of the Donor Selection to the RAC. The RAC acknowledges receipt of the non-cash assets in-kind, captures the encrypted record of the transferred non-cash assets, and validates the decrypted record of the transferred non-cash assets for incorporating into a Recipient Account portfolio.

### RELATED APPLICATION

This application claims the benefit of U.S. Provisional Patent Application Ser. No. 63/158,568, entitled SYSTEM AND METHOD FOR ENABLING THE OPTIMAL SELECTION AND EFFICIENT TRANSFER OF NON-CASH ASSETS FROM A DONORS INVESTMENT ACCOUNT TO CHARITABLE OR NON-CHARITABLE RECIPIENTS ON A SYSTEMATIC, RECURRING BASIS, filed on Mar. 9, 2021, the contents of which are incorporated herein by reference in their entirety for all purposes.

### BACKGROUND

### Technical Field

This invention relates to data management systems and, more particularly, to an automated system for aggregating and transforming data from disparate market trading and portfolio management computers to model, produce and transfer a selection of non-cash assets to charitable and non-charitable recipients on a systematic, recurring basis.

### Background Information

In the U.S., many investors employ an account administrator or implementation manager to implement their investment accounts consistent with the account's stated investment objectives and standing account guidelines and instructions. As an example, an investment account's standing guidelines and instructions may direct the account administrator or implementation manager to invest account assets in publicly traded securities that are selected and managed by to achieve investment performance that closely approximates the returns of a designated market index or a specified blend of market indexes. The account's standing guidelines and instructions may specify that certain designated securities, or groups of securities, shall not be owned in the account and that other individual securities, or groups of securities, shall be held at portfolio weightings that vary by specified amounts or ranges from the weightings of such securities in the designated benchmark portfolio. The account's standing guidelines and instructions may direct the account administrator or implementation manager to reinvest the cash flows generated by the account's investments and additional cash amounts that are invested in the account to purchase additional securities consistent with the account's management objectives and specified investment constraints. The standing guidelines and instructions may further instruct the account administrator or implementation manager to monitor the account's holdings for the development of capital gain or loss in individual portfolio securities and, within specified limits, to periodically sell portfolio securities to realize capital gain or loss consistent with the account objectives, guidelines and instructions. Among the principal advantages of owning individual securities versus investing through pooled vehicles such as mutual funds and exchange-traded funds (ETFs) is the greater control over securities selection, investment and reinvestment of account cash flows, gain/loss realization and other tax management that direct investing affords.

For generations, millions of Americans have made charitable giving a regular practice. Some donate their time and talents; others donate cash, securities or other non-cash assets to support the work of charitable institutions that are important to them. Many charities accept non-cash gifts and encourage the donation of publicly traded securities. While one-time contributions are seldom turned away, most charities place particular value on recurring donations that are predictable in amount and timing, as these provide greater certainty for organizational planning purposes.

In addition to their charitable contributions, many Americans regularly make gifts of cash, securities or other non-cash assets to their children, grandchildren, other family members or other individuals to help pay for the recipient's educational or medical needs and/or to provide income assistance. Here again, recurring gifts that are predictable in amount and timing are especially valuable to the recipient.

In recent decades, a number of larger U.S. public charities have maintained programs through which donors can make cash contributions on a systematic, recurring basis. A need exists, however, for a system and method that facilitates the systematic, recurring contribution of securities and other non-cash assets from a donor's investment account to designated charitable and non-charitable recipients, with the selection, timing and amount of assets transferred optimized consistent with the donor investment account's objectives, guidelines and instructions and the donor's giving plan.

### SUMMARY

In one aspect of the present invention, a specialized portfolio management and securities delivery apparatus efficiently selects and transfers non-cash assets from a donor's investment account to recipients on a systematic, recurring basis. The apparatus includes a series of specialized computers in the form of a Donor Investment Account computer (DIAC), a Portfolio Optimizer Computer (POC), a Market Trading Computer (MTC), and a Recipient Account Computer (RAC). The DIAC is communicably coupled to the POC and to the MTC, and the MTC is communicably coupled to the RAC. The DIAC captures and reconciles positions from an account database and executes trades for the Donor Investment Account. The DIAC includes a first stored program configured to transmit portfolio data to the POC, the portfolio data including portfolio information for the Donor Investment Account in a native DIAC format.

A second stored program is configured to cause the POC to:
(a) receive the portfolio data from the DIAC;
(b) store and apply an electronic time-stamp to the portfolio data in the native DIAC format;
(c) apply a set of rules to the Donor Investment Account portfolio to generate a Donor Selection for the contribution of non-cash assets from the Donor Investment Account;
(d) tag the Donor Investment Account to preserve the Donor Selection for transfer to the RAC;
(e) translate the Donor Selection into a native MTC format; and
(f) encrypt and transmit the translated Donor Selection to the MTC.

The MTC is configured to receive and decrypt the translated Donor Selection; to effect transfer of the non-cash assets in-kind to the RAC; and to generate, encrypt, and transmit a record of the transferred non-cash assets to the RAC in the native MTC format.

A third stored program is configured to cause the RAC to:
(g) acknowledge receipt of the non-cash assets in-kind, and to the capture the encrypted record of the transferred non-cash assets from the MTC in the native MTC format;
(h) decrypt, store and apply another electronic time-stamp to the encrypted record of the transferred non-cash assets;
(i) translate, validate and transform the decrypted record of the transferred non-cash assets to incorporate securities represented by the record into a Recipient Account portfolio administered by the RAC in a native RAC format.

Another aspect of the present invention includes a method of operating a specialized portfolio management and securities delivery apparatus to efficiently select and transfer non-cash assets from a donor's investment account to recipients on a systematic, recurring basis. The method includes: communicably coupling a specialized Donor Investment Account computer (DIAC), Portfolio Optimizer Computer (POC), Market Trading Computer (MTC), and Recipient Account Computer (RAC), to one another; transmitting portfolio data for the Donor Investment Account to the POC; and receiving and time-stamping the portfolio data at the POC. The POC then applies a set of rules to the Donor Investment Account portfolio to generate a Donor Selection for the contribution of non-cash assets, tags the Donor Selection to preserve it for transfer, translates the Donor Selection into a native MTC format, and encrypts and transmits the translated Donor Selection. The MTC receives and decrypts the Donor Selection, transfers the non-cash assets in-kind to the RAC, and then encrypts and transmits a record of the transferred non-cash assets. The RAC acknowledges receipt of the non-cash assets in-kind, captures, decrypts, stores and time-stamps the encrypted record of the transferred non-cash assets. The RAC then translates and validates the decrypted record of the transferred non-cash assets to incorporate securities represented by the record into a Recipient Account portfolio administered by the RAC in a native RAC format.

The features and advantages described herein are not all-inclusive and various embodiments may include some, none, or all of the enumerated advantages. Additionally, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention is illustrated by way of example and not limitation in the figures of the accompanying drawings, in which like references indicate similar elements and in which:

FIG. 1 is a high-level functional block diagram illustrating an embodiment of the present invention in a representative environment;

FIG. 2 is a detailed functional block diagram of a portion of a more detailed embodiment of the present invention;

FIG. 3 is a detailed functional block diagram of another portion of a more detailed embodiment of the present invention; and

FIG. 4 is a block diagram of one embodiment of a computer system usable with aspects of the present invention.

### DETAILED DESCRIPTION

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below. Additionally, unless otherwise specifically noted, articles depicted in the drawings are not necessarily drawn to scale. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents.

### General Overview

A system and method is provided to enable the optimal selection and efficient transfer of non-cash assets from a donor's investment account (Donor Investment Account) to the account of one or more recipients (Recipient Accounts) on a systematic, recurring basis. The selection of securities or other non-cash assets transferred from the Donor Account is implemented using a specialized DIAC (Donor Investment Account Computer) 10 that incorporates a POC (Portfolio Optimizer Computer) 12. Receipt of the transferred non-cash assets into the Recipient Accounts is effected using a specialized RAC (Recipient Account Computer) 14. In particular embodiments, the asset transfer is effected via a specialized MTC (Market Trading Computer) 16 of the type commonly used to handle in-kind exchanges of securities for ETFs or other transfers of non-cash assets. Recipient Accounts may variously include (i) accounts held in the name of or for the benefit of charitable entities, (ii) accounts held in the names of or for the benefit of individuals other than the Donor, (iii) other accounts held in the name of or for the benefit of the Donor, and (iv) accounts held in the name of or for the benefit of non-charitable entities. In representative embodiments of the invention, the selection, timing and amount of assets transferred from a distributing DIAC 10 to a receiving RAC 14 is determined by the POC 12 using optimization algorithms established, maintained and operated by the administrator of the Donor Investment Account and based on investment objectives and standing guidelines and instructions established with the Donor. Elements of these embodiments include (i) the system and method by which the account administrator determines the selection, timing and amount of assets to be transferred from the DIAC 10 to a receiving RAC 14, (ii) the system and method by which the DIAC 10 effects the transfer of selected assets and (iii) the system and method by which the RAC 14 effects receipt of the donated assets.

### Terminology

As used in the specification and in the appended claims, the singular forms “a,” “an” and “the” include plural referents unless the context clearly indicates otherwise. For example, reference to “a computer” includes a plurality of such computers.

Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

Programming Languages

Aspects of the system and method embodying the present invention can be programmed in any suitable language and technology, such as, but not limited to: Assembly Languages, C, C++; Visual Basic; Java; VBScript; Jscript; Node.js; BCMAscript; DHTM1; XML and CGI. Alternative versions may be developed using other programming languages including, Hypertext Markup Language (HTML), Active ServerPages (ASP) and Javascript. Any suitable database technology can be employed, such as, but not limited to, Microsoft SQL Server, as well as big data and NoSQL technologies, such as, but not limited to, Hadoop or Microsoft Azure.

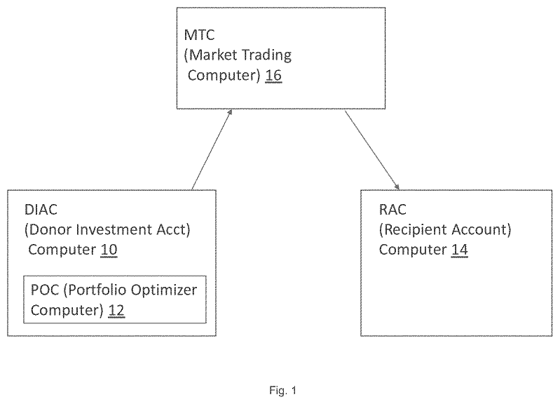

An embodiment of the invention is now described at a high level with reference to FIG. 1. As shown, this embodiment includes a portfolio optimizer (POC 12) communicably coupled to (and/or integrated within, as shown) the Donor Investment Account's account management system (DIAC 10). Examples of conventional DIACs 10 that may be used in particular embodiments of the present invention include the Portfolio™ Account Management System (AMS) commercially available from FundCount, Norwood, Mass. 02062, or the Argos™ AMS running the Verona™ optimization engine, by Parametric Portfolio Associates, LLC (Seattle, Wash.) to implement its Custom Core® system (the ‘Custom Core AMS’). Custom Core accounts are individual separate accounts managed on a customized basis to achieve the particular client's desired market exposure at low cost and with high tax-efficiency. POC 12 may thus be implemented using a commercially available portfolio optimization system such as the aforementioned Verona™ optimization engine modified in accordance with the teachings herein. DIAC 10 is communicably coupled (over secure transport—e.g., encrypted SFTP) to the AMS of one or more Recipient Accounts (RAC 14), e.g., via a specialized in-kind transfer system (MTC 16), such as one that uses the DRS (Direct Registration System) commercially available from DTC (The Depository Trust Company, New York, N.Y.), to transfer the securities ‘in-kind’ to RAC 14. An example of an RAC 14 that may be used in embodiments of the present invention includes an AMS used to implement the donor-advised funds (DAFs) of the U.S. Charitable Gift Trust™, a qualified public charity sponsored by Eaton Vance Management (Boston, Mass.), that enable donors to make charitable contributions of cash, securities and other non-cash assets, and to then select from one or more of various investment options into which the donation will be invested. MTC 16 is also communicably coupled (over secure transport—e.g., encrypted SFTP) to one or more RAC 14. Like DIAC 10, an example of a RAC 14 suitable for use with embodiments of the invention is an OMS commercially available from CRD.

It is noted that the aforementioned embodiment uses a combination of specialized computers which include the in-kind transfer system (MTC 16), which transfers the securities ‘in-kind’ to RAC 14, e.g., in the manner conventionally used to help manage ETF creations and redemptions. Such ETF OMSs handle the sophisticated operational flows associated with ETFs, including the ability to make in-kind transfers of securities, and the ability to accurately handle the accounting side of the operation. These sophisticated capabilities are leveraged by embodiments of the present invention.

The DIAC 10 is also a specialized computer, which for example, leverages the aforementioned Custom Core AMA that was developed to manage individual separate accounts on a customized basis to achieve the particular client's desired market exposure at low cost and with high tax-efficiency.

The RAC 14 is also a specialized computer, which, for example, includes the AMS used to implement the DAFs of the U.S. Charitable Gift Trust.

In these embodiments, systematic charitable giving is provided by linking a Donor's Custom Core account at DIAC 10 to his or her DAF account at RAC 14, e.g., via MTC 16. DAIC 10 may then be configured to systematically fund a designated amount of charitable contributions over a given monthly, quarterly or annual period in accordance with a giving plan established by the Donor, with POC 12 selecting the securities for contribution from the Donor Investment Account consistent with the account's investment objectives, guidelines and instructions and the Donor's giving plan. For example, POC 12 may select the securities for contribution so as to reduce the Donor Investment Account's tracking error versus the account's benchmark and/or to remove low-basis securities from the account without realizing taxable gains. These embodiments thus facilitate systematic gifts of non-cash assets from a Donor Investment Account on a recurring basis, in which the selection, timing and amount of assets transferred is determined using an optimizer based on the account's investment objectives and standing guidelines and instructions established by the Donor.

The foregoing embodiments thus provide (1) functionality within a DIAC 10, via POC 12, to enable the optimal selection of securities to meet a predetermined giving budget or target giving amount, and (2) building automated linkages between the DAIC 10 and the RAC 14 to facilitate the efficient transfer of donated securities. The POC 12 determines the selection, timing and amount of securities transferred to, e.g., reduce the Donor Investment Account's tracking error versus benchmark and/or to reduce the amount of embedded gain in the account. In addition to facilitating the optimal selection of securities for, and the efficient execution of, gifts of securities to charity, these embodiments also have utility for other types of systematic securities transfers from a Donor Investment Account, including gifts of appreciated securities to family members or other individuals. Even though individuals who receive gifts of securities assume the Donor's cost basis, gains realized by the recipient may be subject to substantially less tax than if realized by the Donor, due to graduated federal capital gain tax rates that apply in the U.S.

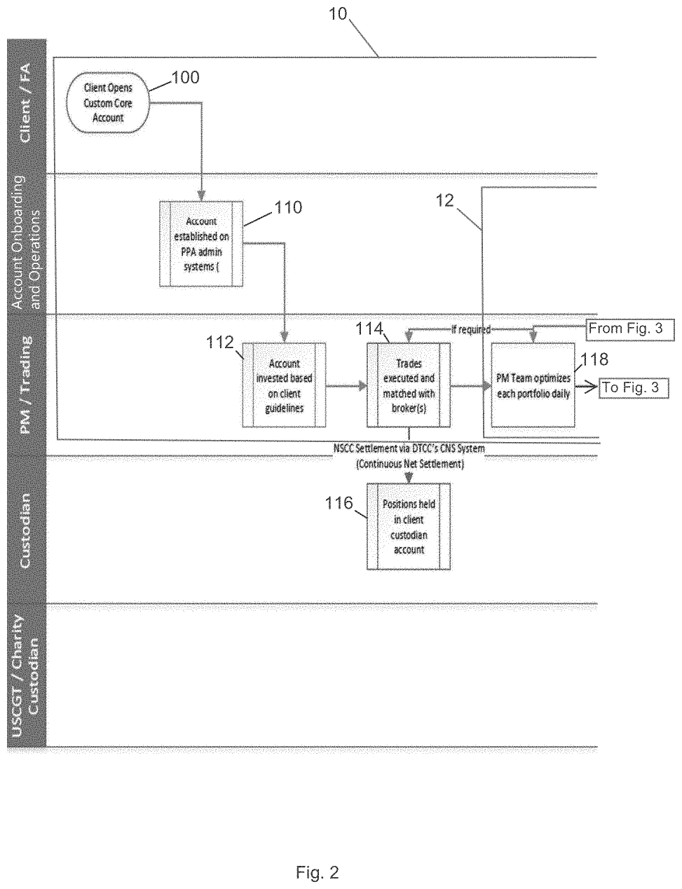

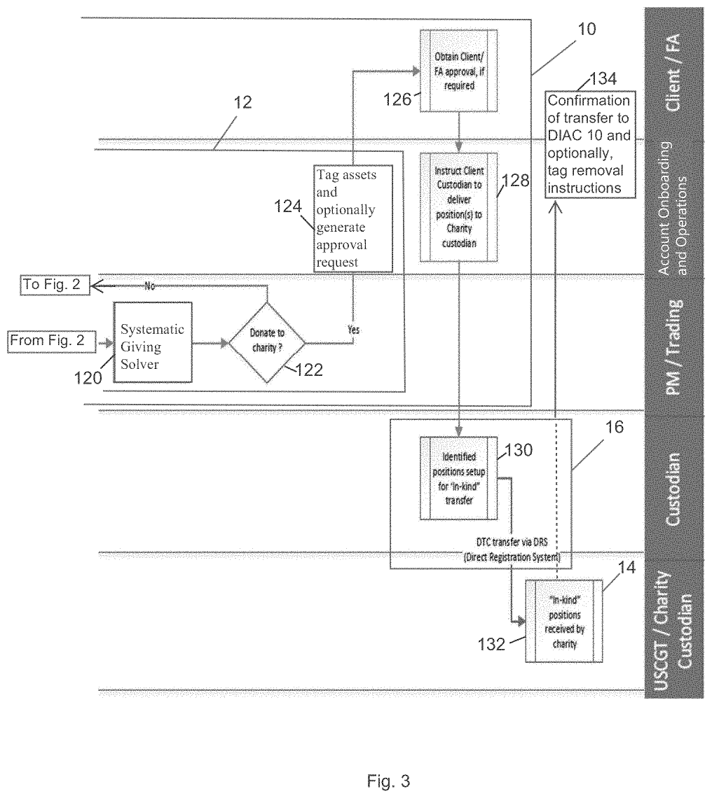

Turning now to FIGS. 2 and 3, a more detailed representative embodiment of the present invention is shown and described. At 100, DIAC 10 receives a request to open a Donor Investment Account (e.g., Custom Core account) according to various client guidelines, including a client-defined DAF/charitable giving budget, and establishes the account within the Custom Core AMS at 110, where once established, is reconciled against custodian holdings, e.g., in an account database, and transactions on a daily basis. At 112, the account is configured for trading assets in a substantially conventional manner, based on the client guidelines. At 114, DIAC 10 executes trade orders and matches the orders with brokers, e.g., using the Newport® Execution Management System (EMS) (Instinet, LLC, New York, N.Y.). The trades are then settled at 116, in a substantially conventional manner, such as using DTCC's Continuous Net Settlement (CNS) system (The Depository Trust & Clearing Corporation, New York, N.Y.). Portfolio data for the Donor Investment Account, including the holdings/positions, is disposed in a native DIAC format.

At 118, POC 12 receives, stores, and electronically time-stamps the portfolio data in the native DIAC format, and, e.g., using the Verona™ optimization engine, screens each account portfolio, e.g., daily, to identify trading opportunities based on the aforementioned client guidelines. Steps 114 and 116 may then be repeated to trade and settle based on any identified opportunities. Turning now to FIG. 3, at 120, a Systematic Giving Solver, e.g., in the form of the Verona optimization engine modified in accordance with the teachings hereof, applies a set of rules to identify assets within the Custom Core account as potential gift candidates (the ‘Donor Selection’). For example, various embodiments may simply identify assets held more than 1 year that have an unrealized gain percentage that exceeds a predetermined threshold. Particular embodiments may implement one or more of the following steps to generate the Donor Selection:

1. Capture, from DAIC 10, the client-defined DAF/charitable giving budget associated with the client account established at 100-112. Various embodiments may use an annual budget, while other embodiments may use shorter term, e.g., monthly, budgets, which may be routinely updated by the client.

2. Maintain a running (e.g., YTD or monthly) total value of donated securities.

3. Calculate remaining DAF budget.

4. Optionally, apply a buffer value to the DAF budget to allow for fluctuations in values of securities, e.g., between date of identification of assets to donate and actual donation date.

5. Identify assets with one or more of the following characteristics:
a. long-term gain (e.g., appreciated assets held more than 1 year);
b. overweighted beyond benchmark exposure or limits of client guidelines; and
c. at least a predetermined percent appreciation (‘gift appreciation threshold’), as per client guidelines.

For example, (a) client account holds XYZ Corp. common stock (XYZ) with unrealized long-term gain equal to 0.50% (50 basis points) of account value, (b) the account's holding of XYZ equals 2.5% of account value, while the benchmark weight of XYZ is 2.0%; and (c) the account's gift appreciation threshold is 0.25% (25 basis points). The system then identifies up to 0.5% of the XYZ shares as a candidate for giving, subject to the client's DAF budget.

It should also be noted that particular assets/securities may be selected for giving so as to reduce the Donor Investment Account's tracking error versus the account's benchmark and/or to remove low-basis securities from the account without realizing taxable gains. These embodiments thus facilitate systematic gifts of non-cash assets from a Donor Investment Account on a recurring basis, in which the selection, timing and amount of assets transferred is determined using the Systematic Giving Solver at 120 based on the account's investment objectives and standing guidelines and instructions established by the Donor.

In particular embodiments, once the foregoing rules have been applied to generate the Donor Selection, the POC tags the assets in the Donor Selection for giving at 124, until the DAF budget is met or the remaining asset portfolio reaches other limits, such as security risk rails and/or benchmark weight, etc. This tagging helps to avoid intervening sales of the identified assets, such as due to periodic tax-loss harvesting, etc., to effectively preserve the Donor Selection for subsequent transfer to the RAC 14, as described hereinbelow. It should be noted that, in particular embodiments, tagging 124 is applied to the particular assets, e.g., in lots. Alternatively, various embodiments may effect tagging by simply freezing trading for the entire client Donor Investment Account until the in-kind transfer has been completed at 132. Combinations of these two tagging approaches may also be useful in particular applications. Various embodiments also automatically generate and transmit a request, e.g., via email, to a designee of the Donor Investment Account for approval to donate the assets in the Donor Selection.

Once tagging is completed at 124, and any requisite approvals are obtained at 126, the POC, e.g., via DAIC 10, translates the Donor Selection into a native MTC format, then sends instructions with the translated Donor Selection at 128, e.g., automatically via encrypted communications as discussed hereinabove, to the MTC 16. MTC 16 receives and decrypts the instructions, including the Donor Selection, and then effects in-kind transfer of the identified assets at 130, e.g., via the aforementioned DTC DRS system, to RAC 14 at 132. MTC 16 then generates, encrypts, and transmits a record of the transferred non-cash assets to the (RAC).

Upon delivery, RAC 14 acknowledges receipt of the non-cash assets in-kind, and captures, decrypts, stores, and applies another electronic time-stamp to the encrypted record of the transferred non-cash assets from the MTC. The RAC then technically validates and transforms the decrypted record of the transferred non-cash assets to incorporate securities represented thereby into a Recipient Account portfolio administered by the RAC.

Once giving is completed, confirmation of the transfer is sent, e.g., from RAC 14 and/or MTC 16, to DIAC 10 at 134, to enable DIAC 10 to reconcile the client account's post-gift holdings. In particular embodiments, confirmation 134 also includes instructions to remove any remaining restrictions (tags) imposed at 124, from the client account, e.g., as of the time indicated by the second time-stamp.

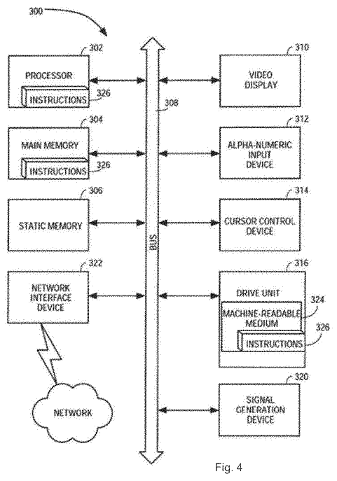

FIG. 4 shows a diagrammatic representation of a machine in the exemplary form of a computer system 300 within which a set of instructions, for causing the machine to perform any one of the methodologies discussed above, may be executed. In alternative embodiments, the machine may include a network router, a network switch, a network bridge, Personal Digital Assistant (PDA), a cellular telephone, a web appliance or any machine capable of executing a sequence of instructions that specify actions to be taken by that machine.

The computer system 300 includes a processor 302, a main memory 304 and a static memory 306, which communicate with each other via a bus 308. The computer system 300 may further include a video display unit 310 (e.g., a liquid crystal display (LCD), plasma, cathode ray tube (CRT), etc.). The computer system 300 may also include an alpha-numeric input device 312 (e.g., a keyboard or touchscreen), a cursor control device 314 (e.g., a mouse), a drive (e.g., disk, flash memory, etc.,) unit 316, a signal generation device 320 (e.g., a speaker) and a network interface device 322.

The drive unit 316 includes a computer-readable medium 324 on which is stored a set of instructions (i.e., software) 326 embodying any one, or all, of the methodologies described above. The software 326 is also shown to reside, completely or at least partially, within the main memory 304 and/or within the processor 302. The software 326 may further be transmitted or received via the network interface device 322. For the purposes of this specification, the term “computer-readable medium” shall be taken to include any medium that is capable of storing or encoding a sequence of instructions for execution by the computer and that cause the computer to perform any one of the methodologies of the present invention, and as further described hereinbelow.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems. Moreover, the particular naming of the components, capitalization of terms, the attributes, data structures, or any other programming or structural aspect is not mandatory or significant, and the mechanisms that implement the invention or its features may have different names, formats, or protocols.

Moreover, unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Embodiments of the present invention also relate to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible, non-transitory, computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), any other appropriate static, dynamic, or volatile memory or data storage devices, or other type of media suitable for storing electronic instructions, and each coupled to a computer system bus. Furthermore, the computers referred to in the specification may include a single processor or may be architectures employing multiple processor designs for increased computing capability.

In addition, the present invention is not described with reference to any particular programming language. It is appreciated that a variety of programming languages may be used to implement the teachings of the present invention as described herein, and any references to specific languages are provided for disclosure of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. It should be further understood that any of the features described with respect to one of the embodiments described herein may be similarly applied to any of the other embodiments described herein without departing from the scope of the present invention. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

Having thus described the invention, what is claimed is:

1. An apparatus having a plurality of specialized computers operating as part of a specialized portfolio management and securities delivery network to efficiently select and transfer non-cash assets from a donor's investment account to one or more charitable or non-charitable recipients on a systematic, recurring basis, wherein the specialized computers collectively select the donated assets and effect their transfer, including securely communicating the selection and transfer of the selected assets and electronically validating and transforming the selection data, the apparatus comprising:
a specialized Donor Investment Account computer (DIAC);
a specialized Portfolio Optimizer Computer (POC);
a specialized Market Trading Computer (MTC);
a specialized Recipient Account Computer (RAC);
the DIAC communicably coupled to the POC and to the MTC, and the MTC communicably coupled to the RAC;
the DIAC configured to capture and reconcile positions from an account database and to execute trades for the Donor Investment Account, the DIAC having a first memory, a first processor, and a first stored program in the first memory executable by the first processor, the first stored program configured to cause the DIAC to transmit portfolio data to the POC, the portfolio data including portfolio information for the Donor Investment Account including the positions, the portfolio data being disposed in a native DIAC format;
the POC having a second memory, a second processor, and a second stored program in the second memory executable by the second processor, the second stored program configured to:
(a) cause the POC to receive the portfolio data from the DIAC;
(b) cause the POC to store and apply an electronic time-stamp to the portfolio data in the native DIAC format;
(c) cause the POC to apply a set of rules to the Donor Investment Account portfolio to generate selection data (Donor Selection) for the contribution of non-cash assets from the Donor Investment Account;
(d) cause the POC to apply one or more electronic tags to the Donor Investment Account to preserve the Donor Selection for transfer to the RAC;
(e) cause the POC to translate the Donor Selection into a native MTC format; and
(f) cause the POC to encrypt and transmit the translated Donor Selection to the MTC;
the MTC configured: to receive and decrypt the translated Donor Selection; to effect transfer of the non-cash assets in-kind to the RAC; and to generate, encrypt, and transmit a record of the transferred non-cash assets to the RAC in the native MTC format; and
the RAC having a third memory, a third processor, and a third stored program in the third memory executable by the third processor, the third stored program configured to:
(g) cause the RAC to acknowledge receipt of the non-cash assets in-kind, and to the capture the encrypted record of the transferred non-cash assets from the MTC in the native MTC format;
(h) cause the RAC to decrypt, store and apply another electronic time-stamp to the encrypted record of the transferred non-cash assets;
(i) cause the RAC to translate, technically validate and transform the decrypted record of the transferred non-cash assets to incorporate securities represented by the record of the transferred non-cash assets into a Recipient Account portfolio administered by the RAC in a native RAC format.

2. The apparatus of claim 1, wherein the third stored program is further configured to cause the RAC to generate a confirmation of receipt of the transferred non-cash assets to the DIAC to enable the DIAC to reconcile post-gift holdings of the Donor Investment Account.

3. The apparatus of claim 2, wherein said one or more electronic tags are applied to all assets within the Donor Investment Account, and/or to particular assets within the Donor Investment Account.

4. The apparatus of claim 3, wherein the third stored program is further configured to cause the RAC to generate and transmit instructions to the DIAC to remove any of said one or more electronic tags from the Donor Investment Account after a time indicated in said other time-stamp.

5. The apparatus of claim 1, wherein the second stored program is further configured to generate and transmit a request for approval to a designee of the Donor Investment Account, for approval to donate the assets in the Donor Selection.

6. The apparatus of claim 1, wherein the set of rules applied to the Donor Investment Account portfolio include identifying assets held more than 1 year at a predetermined percentage of gain.

7. The apparatus of claim 6, wherein the set of rules applied to the Donor Investment Account portfolio include instructions to:
(i) capture a charitable giving (DAF) budget associated with the client account;
(ii) maintain a running value of donated securities;
(iii) calculate remaining DAF budget and/or apply a buffer value to the DAF budget;
(iv) identify assets with one or more of long-term gain, overweight beyond benchmark exposure or limits of predetermined client guidelines, and at least a predetermined percent appreciation.

8. The apparatus of claim 1, wherein the first and second stored programs are configured to repeat said (a)-(i) continuously at predetermined intervals.

9. A method of operating a plurality of specialized computers as part of a specialized portfolio management and securities delivery network to efficiently select and transfer non-cash assets from a donor's investment account to one or more charitable or non-charitable recipients on a systematic, recurring basis, wherein the specialized computers collectively select the donated assets and effect their transfer, including securely communicating the selection and transfer of the selected assets and electronically validating and transforming the selection data, the method comprising:
(a) communicably coupling a specialized Donor Investment Account computer (DIAC) configured to capture and reconcile positions from an account database and to execute trades for the Donor Investment Account, to a specialized Portfolio Optimizer Computer (POC) and to a specialized Market Trading Computer (MTC);
(b) communicably coupling a specialized Recipient Account Computer (RAC) to the MTC;
(c) transmitting, with the DIAC, portfolio data to the POC, the portfolio data including portfolio information for the Donor Investment Account including the positions, the portfolio data being disposed in a native DIAC format;
(d) receiving, with the POC, the portfolio data from the DIAC;
(e) storing and applying, with the POC, an electronic time-stamp to the portfolio data in the native DIAC format;
(f) applying, with the POC, a set of rules to the Donor Investment Account portfolio to generate selection data (Donor Selection) for the contribution of non-cash assets from the Donor Investment Account;
(g) applying, with the POC, one or more electronic tags to the Donor Investment Account to preserve the Donor Selection for transfer to the RAC;
(h) translating, with the POC, the Donor Selection into a native MTC format;
(i) encrypting and transmitting, with the POC, the translated Donor Selection to the MTC;
(j) receiving and decrypting, with the MTC, the translated Donor Selection;
(k) transferring, with the MTC, the non-cash assets in-kind to the (RAC);
(l) generating, encrypting, and transmitting, with the MTC, a record of the transferred non-cash assets to the RAC in the native MTC format;
(m) acknowledging, with the RAC, receipt of the non-cash assets in-kind, and capture of the encrypted record of the transferred non-cash assets from the MTC in the native MTC format;
(n) decrypting, storing and applying, with the RAC, another electronic time-stamp to the encrypted record of the transferred non-cash assets;
(o) translating, technically validating and transforming, with the RAC, the decrypted record of the transferred non-cash assets to incorporate securities represented by the record of the transferred non-cash assets into a Recipient Account portfolio administered by the RAC in a native RAC format.

10. The method of claim 9, further comprising generating, with the RAC, a confirmation of receipt of the transferred non-cash assets to the DIAC to enable the DIAC to reconcile post-gift holdings of the Donor Investment Account.

11. The method of claim 10, wherein said one or more electronic tags are applied to all assets within the Donor Investment Account, and/or to particular assets within the Donor Investment Account.

12. The method of claim 11, further comprising generating and transmitting, with the RAC, instructions to the DIAC to remove any of said one or more electronic tags from the Donor Investment Account after the time indicated in said other time-stamp.

13. The method of claim 9, further comprising generating and transmitting, with the POC, a request for approval to a designee of the Donor Investment Account, for approval to donate the assets in the Donor Selection.

14. The method of claim 9, wherein said applying (f) comprises identifying assets held more than 1 year at a predetermined percentage of gain.

15. The method of claim 14, wherein said applying (f) further comprises:
(i) capturing a charitable giving (DAF) budget associated with the client account;
(ii) maintaining a running value of donated securities;
(iii) calculating remaining DAF budget and/or apply a buffer value to the DAF budget;
(iv) identifying assets with one or more of long-term gain, overweight beyond benchmark exposure or limits of predetermined client guidelines, and at least a predetermined percent appreciation.

16. The method of claim 9, further comprising repeating said (a)-(o) continuously at predetermined intervals.
